(19) United States
(12) Patent Application Publication
(10) Pub. No.: US 2026/0338683 A1
(43) Pub. Date: Oct. 29, 2026

(54) TERAHERTZ IMAGING SYSTEM FOR OPTIMIZING SAMPLE POSITION AND METHODS THEREOF

(71) Applicant: TeraLumen Solutions Pvt. Ltd., Kancheepuram (IN)

(72) Inventors: Jyotirmayee DASH, Kanchipuram (IN); Bala PESALA, Chennai (IN); Shyamsundar MANDAYAM, Bangalore (IN)

(21) Appl. No.: 19/102,557

(22) PCT Filed: Aug. 10, 2023
(86) PCT No.: PCT/IN2023/050767

§ 371 Date: Feb. 10, 2025

(30) Foreign Application Priority Data
Aug. 10, 2022 (IN) 202241033201

(51) Int. Cl. G01N 21/3586; G01N 21/25; G01N 21/3563; G01N 21/39

(52) U.S. Cl. CPC G01N 21/3586; G01N 21/255; G01N 21/3563; G01N 21/39; G01N 2201/0636; G01N 2201/0638

(57) ABSTRACT

The disclosure provides systems and methods for optimizing position of a sample in a terahertz imaging system. The system (200) includes a terahertz imaging apparatus (100), a movement mechanism (140), and a controller (160). The apparatus (100) includes a laser source (102), an emitter (104) including a THz antenna, optical elements (106A,106B) and an RGB camera (105). The laser source may be a femtosecond pulse laser or a tunable continuous wave laser. A method (300) of optimizing the position of the sample is disclosed. Optimizing a position of a sample involves identifying (403) the focal point of THz image. The method involves overlaying (409) the terahertz image with the visible image and detecting the region of interest based on the intensity variation across the terahertz image. The invention is efficient at rapidly optimizing a sample position and identifying cancerous areas in tissue samples, or defects in other types of materials.

### CROSS-REFERENCES TO RELATED APPLICATIONS

This application claims priority to provisional patent application No. 202241033201 entitled TERAHERTZ IMAGING SYSTEM FOR OPTIMIZING SAMPLE POSITION AND METHODS THEREOF filed on 10 Aug. 2022.

### FIELD OF THE INVENTION

The present disclosure relates to imaging systems and in particular to a terahertz imaging system and apparatus for optimizing sample position and methods thereof.

### BACKGROUND OF THE RELATED ART

Terahertz (THz) radiation oscillates at frequencies between the microwave and infrared regions of the electromagnetic spectrum i.e. 0.1 and 10 THz. Owing to its non-ionizing and non-invasive nature, THz waves has attracted a lot of interest in various applications such as biomedical imaging, agricultural, security and non-destructive testing for industrial applications. THz techniques can also be applied for quality control of food and drugs due to its sensitivity to water content and to detect structural differences in materials. In order to achieve the best possible results, accurate positioning of the object and optics becomes a prerequisite. Further, invisibility of THz radiation to naked eyes makes determination of scan area and optimization of the focal point more challenging. Additionally, the hardware challenges such as analysing the THz transmitted-reflected coefficients and their interpretation is not quite straight forward.

Researchers from all across the world have used terahertz waves to create various optical imaging systems. For example: Patent application WO2021067635A1 discloses a terahertz scanner and methods for obtaining a characteristic and a reference signal for at least one point amongst the plurality of points of the sample and determines reference features such as peak intensity, average intensity, delay, pulse width, spectral power, phase of the signals, and any combination thereof. Hence, detecting irregularities, such as chemical or structural variations in a sample. The US patent U.S. Pat. No. 9,736,402B2 describes systems and methods for hyperspectral imaging comprising a camera for recording a hyperspectral image of an object and a display device for displaying the recorder hyperspectral image in visible light. Another US patent US20130076912A1 refers to a reflective imaging device and an image acquisition method for generating a two-dimensional image for detecting a biopolymer such as a protein. Yet another US patent US20130076912A1 discloses a terahertz time-domain spectroscopic ellipsometry system that includes a sample stage, a terahertz emitter and a coherent terahertz detection unit.

However, none of the above cited patent documents focus on rapid position optimization of the object/device. Position optimization includes defining the scanning area and obtaining the maximum reflected signal from the scanned area. This produces quick and accurate output. Therefore, a terahertz imaging system and method for rapidly optimizing an object with maximum reflected signal output is needed.

The present disclosure addresses some of the drawbacks of conventional systems and satisfies the need for a system that is simpler in construction, cheaper, more reliable, and through which optimized position for the object is attained quickly, with further related advantages as set forth here.

### SUMMARY OF THE INVENTION

The invention discloses apparatus, systems and methods for terahertz imaging. In various embodiments, the invention discloses a terahertz imaging apparatus comprising at least one laser source, mounted on a laser driver, wherein the laser source is configured to generate optical input. The apparatus further includes at least one fibre optic coupler configured to split, or combine the signals from the laser source. An emitter comprising a terahertz antenna biased by a signal generator in the apparatus is configured to receive the laser beam from the fibre optic coupler to emit terahertz radiation. The apparatus includes at least a pair of optical elements configured to receive the terahertz radiation from the emitter and guide the terahertz radiation towards a sample positioned at a focal point. The sample is configured to be positioned at the focal point using a laser module adapted to visualize the focal point within the visible light spectrum. The apparatus further includes a depth sensor positioned adjacent to the terahertz antenna configured to obtain the distance of the sample from the emitter, an RGB camera to capture images within the visible spectrum configured to define the scanning area of the sample. Further, a detector in the terahertz antenna is configured to receive the laser beam from the fibre optic coupler and the reflected beam from the sample to form the terahertz image.

In various embodiments, the laser source comprises a femtosecond pulse laser or a tunable laser. The femtosecond pulse laser is included in a terahertz time-domain pulse module comprising an optical delay unit, a prism, at least one mirror, at least one collimator and a photoconductive antenna. In some embodiments the apparatus comprises a motorized movement mechanism having a platform configured to hold the sample and move the sample in one or more axis. In various embodiments, the apparatus includes a motorized movement mechanism configured to receive data from the depth sensor and to optimize the position of the sample using a feedback loop.

In various embodiments, the detector is configured to receive reflected radiations from the sample through the optical elements. In some embodiments the optical elements are mirrors, or alternatively, lenses selected from silicon lenses or polymethylpentene (TPX) lenses. In various embodiments, the apparatus comprises a lock-in amplifier and a trans-impedance amplifier to amplify the intensity of the received THz signal. The apparatus may be configured to capture raster scan of the sample pixel by pixel based on the position of the platform.

The invention discloses a terahertz imaging system for optimizing sample position and identifying a region of interest in the sample. The system incorporates the THz imaging device as disclosed. The system further comprises a motorized movement mechanism configured to optimize sample position at focal point of terahertz beam. The movement mechanism, comprises a sample holder, and stepper motors configured to move the sample in x, y and z directions to enable raster scanning of the sample based on the current position of the motorized platform, and to adjust depth position of the sample based on intensity of the THz radiation measured by the detector and the depth sensor. The visible range camera may be configured to optically determine scanning area of the sample and to capture real time image of the sample. The laser unit may incorporate the laser source configured to generate either a femtosecond pulse laser beam or a tunable laser beam. The system includes a graphical user interface (GUI) enabling visualization of the measured THz signal over the scanned area along with a visible image thereof. The system then comprises a controller comprising a computer having at least one processor and memory, communicatively connected to the imaging unit, the motorized movement mechanism, the laser unit and the display unit, for performing various control functions. The controller comprises a terahertz imaging module configured to generate a terahertz image from the raster scan, a visible image processing module configured to receive real-time image from the RGB camera and to extract visible image data, a regulator configured to control the function of the one or more laser drivers located within the laser unit, the lock-in amplifier, and the trans-impedance amplifier, and intensity of the laser source, and a function generator configured to provide bias to the emitter and reference signal to the lock-in amplifier.

In various embodiments of the system, the GUI is configured to display real-time images of the sample. The GUI may allow one or more parameters of the controller to be configured by the user. In various embodiments, the computer comprises a communication interface for wired or wireless communication, configured to communicate in real-time with a remote host. The wireless communication may be via a protocol selected from Bluetooth, WiFi and Zigbee.

The invention further discloses a method of optimizing a position of a sample in a terahertz imaging system and identifying a region of interest in the sample. The method comprises capturing a terahertz image of the sample placed in a motorized platform using a terahertz imaging apparatus. Capturing the image comprises generating optical input by at least one laser source, splitting or combining the signals from the laser source in a fibre optic coupler, receiving the beam from the fibre optic coupler in a THz emitter biased by a signal generator and emitting terahertz radiation, guiding the terahertz radiation from the emitter towards a sample positioned at a focal point through optical elements, obtaining the distance of the sample from the emitter by a depth sensor, defining the scanning area of the sample by a RGB camera within the visible spectrum, receiving the reflected beam from the sample in a detector in the terahertz antenna, and measuring the intensity of the reflected beam after amplification. In the next step, the sample position at the focal point is optimized using a position optimizing unit, comprising receiving data from the depth sensor and measured intensity of the reflected beam in a feedback loop, and optimising the distance between the sample and the device to position the sample at the optimal position to maximise the measured intensity. In a next step, the real-time images of the sample are captured in a RGB camera. Generating a terahertz image from the raster scan is then done in a terahertz imaging module in the controller. In a final step, real-time images from the RGB camera are received to extract visible image data, and the terahertz image is overlaid with the visible image to specify the scan region and the region of interest detected based on the terahertz image.

In some embodiments, the method comprises guiding the motorized movement mechanism to optimize the position of the sample at the focal point. The method in some embodiments may comprise displaying the real-time scanned images of the sample in a graphical user interface (GUI) and setting one or more parameters of the controller through the GUI. In some embodiments, the detecting the region of interest comprises using an image processing algorithm to process the THz image.

In various embodiments, the method comprises communicating wirelessly in real-time through a communication interface with a user authorization module. In some embodiments the method comprises setting one or more parameters of the controller via a software application installed in a mobile device. In various embodiments, the method may include storing data in cloud storage or a local database.

In various embodiments, the method may comprise enhancing contrast of the THz image by an edge detection algorithm, a point spread function deconvolution, a histogram equalization algorithm, a machine learning algorithm, or a deep learning algorithm.

This and other aspects are disclosed herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1A and FIG. 1B show the terahertz imaging apparatus with the internal components.

FIG. 1C shows an external view of the terahertz imaging apparatus with specimen movement mechanism.

FIG. 1D shows the components of the terahertz imaging system.

FIG. 1E illustrates the components of the controller for the THz imaging system.

FIG. 2A represents components of the terahertz-continuous wave system.

FIG. 2B represents components of the terahertz-time domain system.

FIG. 3 illustrates the method of optimizing a position of a sample and identifying a region of interest.

FIG. 4A shows visible image, FIG. 4B shows THz image and 4C show overlapping of visible and THz images.

FIG. 5 shows the generated THz radiation from the system over a frequency range of 0.1 to 0.6 THz.

FIG. 6A-6L show visible light image THz image using continuous wave system, and H&E image, of cancerous tissue with adjacent normal tissues.

FIG. 7A-7I show visible image THz image using time domain system, and H&E image, of cancerous tissue with adjacent normal tissues.

FIGS. 8A and 8B show visible light and THz images of a normalchocolate bar, while FIGS. 8C and 8D show visible light and THz images of a chocolate bar with metal foil contamination.

FIGS. 8E and 8F show visible light and THz images of a metal plate within a packet of baking soda.

FIGS. 8G and 8H show visible light and THz images of a glass piece within a packet of noodles.

FIGS. 8I and 8J show visible light and THz images of metal foil within a packet of noodles.

FIG. 9A-9D show terahertz imaging results of cryofoam samples with bright areas in the THz images showing defects.

FIG. 10A-10B show visible light and THz images of glass fiber reinforced polymer (GFRP) samples containing defects.

FIG. 11A-11C shows the terahertz imaging results of thermal barrier coating samples with their images (using Time Domain imaging system).

Throughout the drawings, like numbers indicate like parts.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adopt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.”

Referring to the drawings, like numbers indicate like parts throughout the views. Additionally, a reference to the singular includes a reference to the plural unless otherwise stated or inconsistent with the disclosure herein.

The disclosure provides systems devices and methods optimizing position of a sample in a terahertz imaging system. The system includes a terahertz imaging apparatus, a motorized movement mechanism, and a controller. The terahertz imaging apparatus is configured to obtain the image of a sample placed in an optimized position and includes at least one laser source, a fibre optic coupler, an emitter that includes a THz antenna, a pair of optical elements that may be lenses or mirrors, a depth sensor, the RGB camera, and one or more amplifiers. The laser source may be a femtosecond pulse laser or a tunable laser. Based on the laser source and photomixers, the system may be a terahertz time domain system or a continuous wave THz system. Further a method of optimizing the position of the sample is disclosed. In various embodiments, a method of optimizing a position of a sample in a terahertz imaging system and identifying a region of interest in a sample based on intensity of terahertz radiation received from the sample is disclosed. The invention is efficient at rapidly optimizing a sample position by analysing the focal point of THz radiation incidence on the sample and determining intensity of reflected radiation. Although the invention is illustrated with reference to imaging reflected THz radiation, it will be understood that the devices and systems disclosed are equally applicable to transmitted imaging using THz radiation.

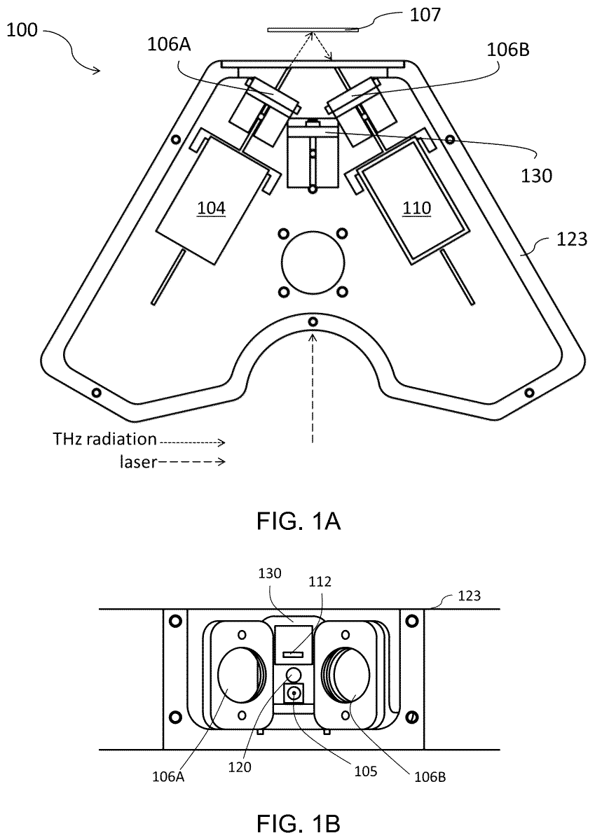

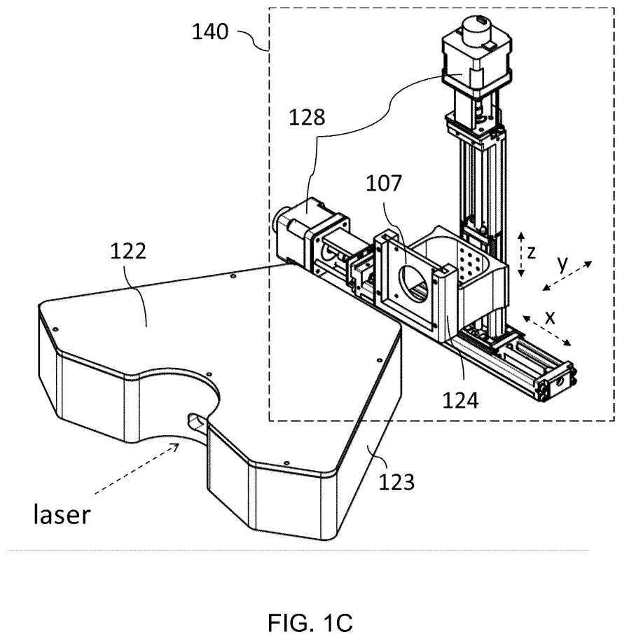

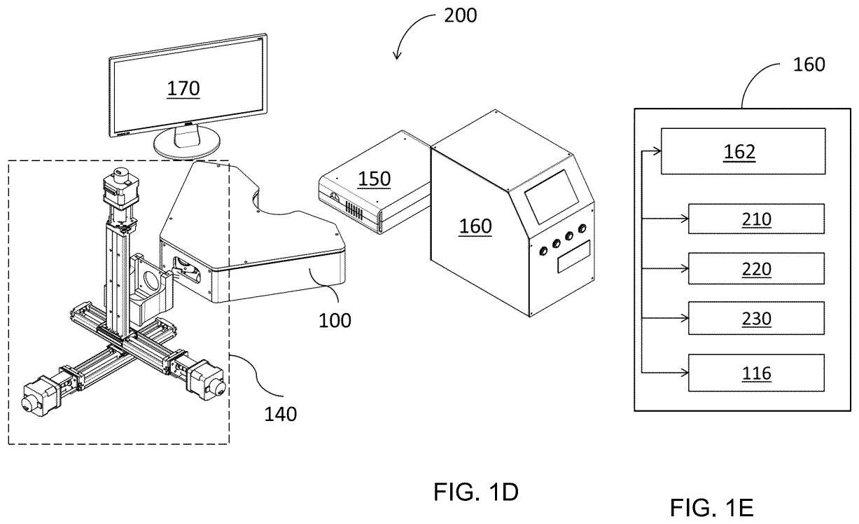

In various aspects, a terahertz imaging apparatus 100 is disclosed with reference to the figures. FIG. 1A and FIG. 1B illustrate internal components of the terahertz imaging apparatus. As shown in FIG. 1A, an emitter 104 to emit THz beam to a sample 107, a detector 110 to receive the reflected beam from the sample, and a pair of optical elements 106A, 106B to guide the terahertz radiation towards the sample. The apparatus includes a sensor plate 130 as further illustrated in detail in FIG. 1B. The optical elements in one embodiment are special lenses 106A, 106B configured to focus the terahertz radiation towards the sample. As shown in FIG. 1B, the sensor plate 130 includes a depth sensor 112, a RGB camera 105, and a laser aperture 120.

An external view of the terahertz imaging apparatus with 3-axis movement mechanism 140 is illustrated in FIG. 1C according to embodiments of the present subject matter. The apparatus 100 includes a box 123 covered with a lid 122 configured to safely enclose the internal components. The apparatus further includes a motorized platform 124 configured to hold and move the sample. The motorized movement mechanism 140 comprises stepper motors 128 adapted to move the sample in x, y and z axes as shown in the figure. The sample is moved in one or more axes to capture two-dimensional (2D) images of the sample. In various embodiments, a third axis for the movement of the device or the sample is included. The third axis movement helps in optimizing the position of the sample to focus the THz radiation thereon. In various embodiments, the apparatus 100 includes a feedback loop configured to receive data from the depth sensor 112 and to optimize the position of the sample.

In various embodiments, a system 200 incorporating the imaging device 100 is shown in FIG. 1D. As shown in FIG. 1D, the system includes THz imaging device 100, motorized movement mechanism 140, laser unit 150, control unit 160 and display 170. The control unit 160 is configured to receive the feedback from the depth sensor 112 and automatically control the position of the sample holder 124 to maintain focus of the THz image. In various embodiments the apparatus is configured to capture a raster scan of the sample, pixel by pixel using the movement of the motorized platform 124.

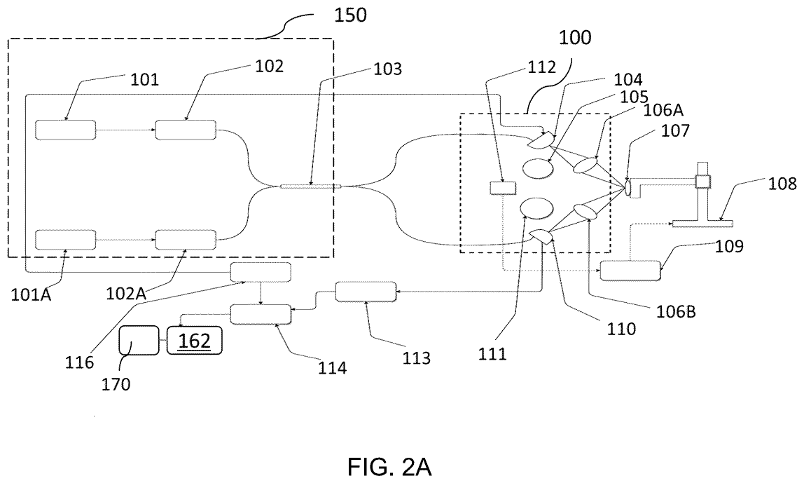

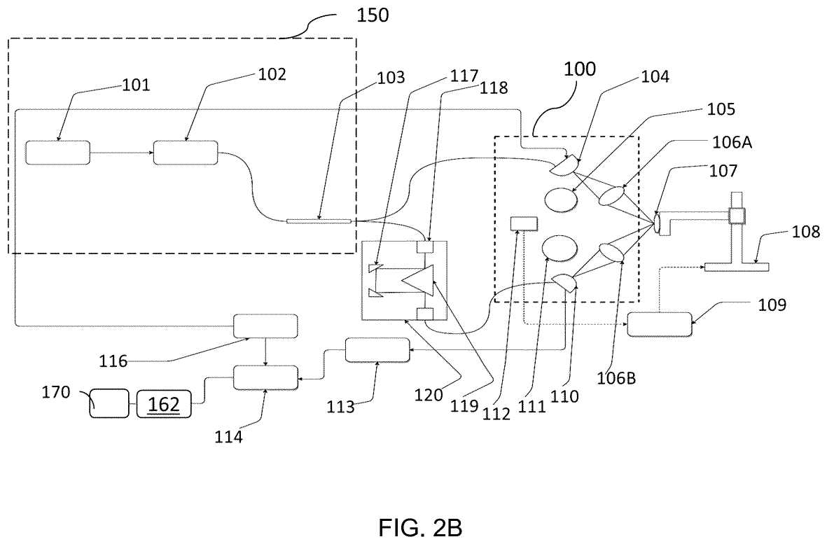

In various embodiments, the apparatus includes optical elements 106A, 106B configured to capture the terahertz radiation and produce the diverging terahertz beam as illustrated in FIG. 2A and FIG. 2B. The apparatus includes at least one laser source 102, as shown in FIGS. 2A and 2B. The laser source is mounted on a laser driver 101. The laser source 102 is configured to generate an optical input to the emitter comprising a terahertz antenna. In various embodiments, the laser source 102 is a femtosecond pulse laser or a tunable laser. In various embodiments, the optical input from the light sources 102 are split or combined in the fibre optic coupler 103 in a predetermined ratio to form the laser beam. The emitter 104 is biased by a signal generator and s configured to receive the laser beam from the fibre optic coupler 103 to emit the terahertz radiation. In various embodiments, the emitter 104 is biased such that the change in conductivity induced by the absorption of the polarized beam creates a photocurrent that drives a dipole antenna and this radiates the terahertz frequencies. A signal generator is configured to provide the bias to the emitter 104 for generating the terahertz radiation.

In various embodiments, the optical elements 106A, 106B may be silicon lenses or polymethylpentene (TPX) lenses suitable for THz wavelengths. In alternative embodiments, the lenses may be replaced by suitable parabolic mirrors. The lenses or mirrors are firmly held in lens holders. In one embodiment the lenses may have variable focal length. In another embodiment the focal length of the lenses is fixed. The lenses or mirrors 106A, 106B are configured to receive the terahertz radiation from the emitter and guide the terahertz radiation towards the sample 107. In various embodiments the depth sensor 112 is positioned adjacent to the terahertz antenna and is configured to obtain the distance of the sample from the emitter 104. In various embodiments, the sample is placed on the exact focal position of the lens or mirror. The sample position is optimized utilizing the depth sensor 112. In various embodiments, the distance range between the terahertz apparatus and the sample is standardized based on the maximum intensity of the terahertz reflected signal. Once the sample is placed at the optimum position, the sample or the apparatus is automatically moved by the third axis motorized platform based on the feedback from the depth sensor to obtain the maximum intensity of the terahertz reflected signal.

In various embodiments, the apparatus includes a RGB camera 105 as shown in FIG. 1B. The RGB camera is configured to image within the visible spectrum and is configured to define the scanning area of the sample as illustrated in FIG. 2A and FIG. 2B. The receiver antenna is configured to receive the reflected/transmitted beam from the sample. The reflected terahertz beam from the sample is focused on the detector 110 in the terahertz antenna through two lenses or parabolic mirrors. In various embodiments the spectral information from the target is acquired, generating electrical signal representing the spectral information in the terahertz detector 110 in proportion to the intensity of the terahertz signal.

In various embodiments amplifiers 113, 114 are configured to enhance intensity of the received reflected/transmitted radiations that is a function of the electrical signal produced in the detector 110. In various embodiments, the amplifier 114 is a lock-in amplifier and the amplifier 113 is a trans-impedance amplifier. In various embodiments, a reference signal in lock-in amplifier is obtained from the detector. In one embodiment, the lock-in amplifier is a low noise amplifier adapted to amplify the in-phase component of the signal by reducing the noise. In various embodiments the trans-impedance amplifier 113 is connected to the lock-in amplifier 114 to detect the measured THz signal. In various embodiments, the lock-in amplifier 114 is connected to a graphical user interface (GUI) or display 170 for visualizing the measured THz signal over the scanned area.

The system 200 as shown in FIG. 1D includes a terahertz imaging apparatus 100, a control unit 160, a RGB camera 105, a regulator 203 and a control unit 205 having a controller that is configured to identify the region of interest. In various embodiments the terahertz imaging apparatus 100 includes at least a laser source 102 mounted on a laser driver 101, at least one fibre optic coupler 103, an emitter 104 comprising at least one terahertz antenna to emit and receive a terahertz radiation, at least a pair of lenses or mirrors 106A, 106B to guide the terahertz radiation towards the sample, a depth sensor 112 positioned adjacent to the terahertz antenna, a RGB camera 105, a detector 110 and amplifiers 113, 114. In various embodiments, the laser sources 102 are configured to generate THz waveforms that are split or combined in the fibre optic coupler 103 to combine the waveforms from the laser sources in a predetermined ratio to form a single polarized beam. The emitter 104 includes a terahertz antenna that is biased by a wave generator and is configured to receive the beam from the fibre optic coupler 103 to emit a terahertz radiation. In various embodiments the frequency and the channel voltage outputs of a function generator is set.

In various embodiments, the pair of lenses or mirrors 106A, 106B is configured to receive the terahertz radiation from the emitter 104 and guide the terahertz radiation towards a sample 107 positioned at a focal point as illustrated in in FIG. 2A and FIG. 2B. The depth sensor 112 is positioned adjacent to the terahertz antenna and is configured to obtain the distance of the sample 107 from the emitter 104. In various embodiments, a laser module 111 within the visible spectrum is configured to define the scanning area of the sample 107. The detector 110 is configured to receive the optical beam from the fibre optic coupler 103 and reflected/transmitted beam from the sample 107.

In various aspects, the system 200 includes the imaging device as already described with reference to FIG. 1A-B, and a motorized movement mechanism 140 that is configured to optimize the sample position at the focal point. The mechanism 140 includes a sample holder 124, and stepper motors 128 configured to move the sample in x, y and z directions to enable raster scanning of the sample based on the current position of the motorized platform. The mechanism 140 is configured to adjust depth position of the sample based on intensity of the THz radiation measured by the detector 110 and the depth sensor 112.

In various embodiments, the system 200 includes the apparatus 100 with a tunable laser source 102. FIG. 2A represents a terahertz imaging system with a tunable laser source. In various embodiments, the tunable laser is a distributed feedback laser and generates a THz radiation by a continuous wave generation module. The system with tunable laser may provide a narrow frequency bandwidth.

In some embodiments, the system 200 includes the apparatus 100 with a femtosecond pulse laser. FIG. 2B represents a terahertz imaging system with a femtosecond pulse laser source. In various embodiments, the femtosecond pulse laser is used to provide optical signal to the terahertz time-domain pulse module comprising an optical delay unit 120, a prism 119, at least one mirror 117, at least one collimator 118 and a photoconductive antenna. The femtosecond pulse laser generates the THz radiation by illuminating the photoconductive antenna. The optical delay unit may measure the time delay between the excitation pulse and the reflected pulse. In various embodiments, the system 200 with the femtosecond pulse laser may provide information with respect to refractive index, absorption and dispersion properties of the sample 107. The system with femtosecond pulse laser may provide larger bandwidth as compared to the system comprising the tunable laser.

The system 200 includes a graphical user interface (GUI) 170 enabling visualization of the measured THz signal over the scanned area along with a visible image thereof. The GUI may be a monitor or other display device.

In various embodiments, the controller 160 includes a computer 162 with processor, memory and communications interfaces. The controller 160 is communicatively connected to the imaging apparatus 100, and the motorized movement mechanism 140, the laser unit 150 and GUI 170. The control unit includes a controller that includes a terahertz imaging module 210, a visible image processing module 220, a regulator 230 and a function generator 116. The terahertz imaging module 210 is configured to generate a terahertz image by raster scanning of the sample. The terahertz reflected/transmitted intensity is measured over a frequency span at each pixel of the sample and the average intensity or the maximum intensity or power over a spectral range at each pixel of the sample is calculated using an algorithm. The spatial resolution may be defined by the user. In various embodiments, the mapping of average intensity is calculated with corresponding ‘x’ and ‘y’ positions. The visible image processing module 220 is configured to receive real-time image from the visible range-RGB camera and to extract visible image data.

In various embodiments, the GUI or display 170 is configured to display the real-time scanning of the sample. In some embodiments, the one or more parameters of the controller are set by the user through the GUI for example, controlling the laser power through the GUI to provide optical input to the terahertz antenna, setting the frequency of the lasers by tuning the temperature, etc. The GUI is used to overlay the THz image with the visible image to specify the scan region and to detect the region of interest. In various embodiments, the real time scanning of the sample is displayed in the GUI and is correlated with the visible image to identify the region of interest (ROI). The terahertz intensity will differentiate normal/unaffected and abnormal/defective region of the sample. For example, the abnormal region may exhibit higher or lower intensity of THz radiation in the raster image as compared to the surrounding normal region. In various embodiments, the detection module comprises an image processing algorithm to detect the region of interest. In various embodiments, an edge detection algorithm or a point spread function deconvolutions or histogram equalization or a machine learning algorithm or a deep learning algorithm are used to enhance the contrast in the terahertz image. In various embodiments, the region of interest is detected based on an intensity threshold.

The computer 162 may comprise at least one communication interface with a user authorization module configured to wirelessly communicate in real-time. The computer 162 may be provided with communication interfaces for wireless or wired communication. In some embodiments, the wireless interface may include one of a number of protocols, including Bluetooth, WiFi or Zigbee. In various embodiments, the system may be configured to be controlled via a mobile device via a mobile software application. The mobile application may be used to control the individual components of the system remotely. The mobile application may also provide visualizing of the terahertz results and the system status remotely. Either the computer interface or the mobile application may be utilized for data input, data security etc. and for restricting the access of the system to authorized users. In various embodiments, the data generated by the system 200 may be stored in cloud storage or a local non-volatile memory. The stored data may be further accessed from the cloud for future analysis as well as for training an Artificial Intelligence module.

In various embodiments, the regulator 230 is configured to control and regulate the laser driver 101, to regulate the intensity of the laser source 102. In various embodiments, the function generator 116 is configured to provide a bias signal to the emitter 104. The function generator is also adapted to provide reference signal to the lock-in amplifier 114.

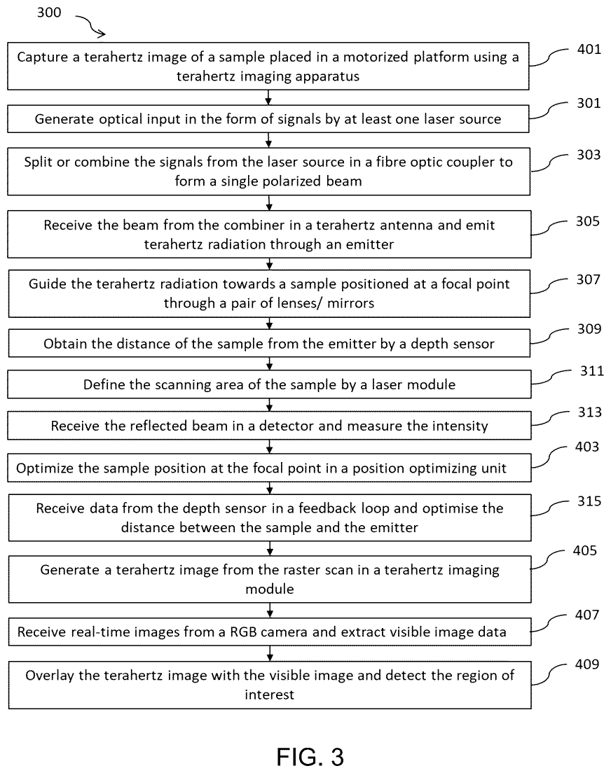

In various aspects, the subject matter is a method of optimizing a position of a sample 300 in a terahertz imaging system and identifying a region of interest in a sample based on intensity of terahertz radiation received from the sample 400 is disclosed. The method as shown in FIG. 3 includes capturing a terahertz image 401 of the sample using a terahertz imaging apparatus. The sample is placed in a motorized platform and is moved to capture a 2D image of the sample. The 2D image of the sample is captured. In step 301, Terahertz waveforms are generated by at least one laser source wherein the laser source may be a femtosecond laser or a tunable laser. In step 303, waveforms from the sources are split or combined in fibre optic coupler in a predetermined ratio to form a single polarized beam. The beam from the fibre optic coupler is received in an emitter, in step 305. The emitter comprises a THz antenna. The emitter is biased by a signal generator and emits a terahertz radiation through an emitter. In various embodiments in step 307, the terahertz radiation from the emitter is received and the terahertz radiation is guided towards a sample positioned at a focal point through at least a pair of lenses/mirrors. In various embodiments, the lens has a variable focal length. In step 309, the distance of the sample from the emitter is obtained by a depth sensor positioned adjacent to the terahertz antenna. In step 311, the scanning area of the sample is defined by a RGB camera and the reflected beam from the sample is received in a detector, in step 313. In various embodiments, the intensity of the reflected beam is measured in an amplifier. Optimizing the sample position at the focal point is performed in step 403, wherein the sample is moved in the motorized platform in at least one of the axes. Further in step 315, data from the depth sensor is received in a feedback loop and the distance between the sample and the emitter is optimized to position the sample at the optimal position. In various embodiments, the feedback loop guides at least one of the axes of the motorized platform to optimize the position of the sample. In one embodiment, the feedback loop guides at the third axis of the motorized platform to optimize the position of the sample at the focal point. The method then involves obtaining in step 405, the THz image with the sample located at the optimized position.

, In various embodiments, the method includes obtaining in step 407, real-time images of the sample using a visible range RGB camera. The next step 409 involves overlaying the terahertz image with the visible image to specify the scan region and for detecting the region of interest. In various embodiments the method as shown in FIG. 3 includes in step 401, capturing the terahertz image of the sample using a terahertz imaging apparatus. The sample is placed in a motorized platform so that the sample may be moved in all three axes and the 2D images of the sample is obtained. In various embodiments capturing the terahertz image includes of a first step generating terahertz waveforms by at least one laser source. The signals from the laser sources are combined in a fibre optic coupler in a predetermined ratio to form a single polarized beam. In various embodiments, an emitter, biased by a signal generator receives the beam from the fibre optic sensor and the emitter emits a terahertz radiation through an emitter. The emitter may be a dipole antenna. The terahertz radiation from the emitter is received and guided towards a sample positioned at a focal point through at least a pair of lenses or mirrors. In various embodiments, the distance of the sample from the emitter is obtained by a depth sensor positioned adjacent to the terahertz antenna. The scanning area of the sample is defined by the RGB camera 105 within the visible spectrum. The reflected beam from the sample is received in a detector in the terahertz antenna and the intensity of the reflected beam is measured in an amplifier. The intensity of the reflected beam is proportional to the current developed in the terahertz antenna based on the signal received.

In various embodiments, the real-time scanning of the sample is displayed in a GUI. In various embodiments, the method includes setting one or more parameters of the controller through the GUI. In various embodiments, the real-time scanning of the sample is correlated with the visible image. In various embodiments, detecting the region of interest includes an image processing algorithm. In various embodiments, contrast between the normal and abnormalities in the sample is enhanced by an edge detection algorithm, or point spread function deconvolution, or histogram equalization algorithm, or machine learning algorithm, or deep learning algorithm. In various embodiments, the method includes communicating wirelessly in real-time through a communication interface with a user authorization module. In various embodiments, the method is incorporated in a mobile device as an application. The method includes controlling the individual components of the system remotely and visualizing the terahertz results and the system status remotely. The mobile application stores the organization/device details and also restricts the access of the system by an unauthorized user. In various embodiments, the method includes storing the data from the system in cloud storage or a local database. The stored data may be further accessed from the cloud for future analysis.

In various embodiments, the system 200 is adapted to rapidly identify the optimum position of the sample. Further, the automated software of the system allows distance and position assessment of the sample in a swift manner. In various embodiments, the data interpretation software of the system helps the user to accurately analyze, interpret the results and detect the abnormality in the sample. In various embodiments, the variable lens in the device enables the system to be utilized in varied number of applications. In some embodiments, the apparatus 100, the system 200 and the method 300 of the present invention are scalable and have been experimentally validated to demonstrate rapid identification of various samples. The system and methods of the present invention may be used for rapid identification of cancerous or normal tissue. The system and methods may also be used for food quality monitoring. The system and methods may be used to rapidly detect glass, metal or plastic contamination in food samples. In various embodiments, the system and methods of the present invention may be used in non-destructive testing of various samples. The system and methods are configured to efficiently provide real-time imaging of debonding occurring in cryofoam samples. The system and methods may be used to detect non-uniformity in glass fibre reinforced polymer (GFRP) samples. The system and methods are configured to evaluate the degree of degradation of thermal barrier coatings.

While the invention has been disclosed with reference to certain embodiments, it will be understood by those skilled in the art that various changes may be made and equivalents may be substituted without departing from the scope of the invention. In addition, many modifications may be made to adapt to a particular situation or material the teachings of the invention without departing from its scope, as defined by the claims.

### EXAMPLES

### Example 1: Fabrication and Working of Terahertz Imaging Device

A compact and non-invasive terahertz imaging device with dimensions of 20 cm×30 cm×6.5 cm was fabricated. Two versions of the device were fabricated. In the first version, the device included a femtosecond pulsed laser for induced imaging through terahertz time domain system (TDS). In the second version, the device had a tunable laser induced imaging through a continuous-wave (CW-THz) system. Table-1 below provides the differences between TDS and CW-THz with respect to their working and components.

TABLE 1
Represents The Salient Features Of The Fabricated
Apparatus With Different Laser Sources.

| Features | Continuous Wave System | Time Domain System |
|---|---|---|
| Optical Source | Distributed Feedback | Femtosecond Laser |
| | Laser/Tunable laser | (Pulsed Laser) |
| | (Continuous Wave Laser) | |
| Bias Source | Sine wave Generator | Sine Wave Generator |
| Additional | — | Optical Delay Unit, |
| Requirement | | Prism, |
| | | Mirror, Collimator |
| Spectral Output | Frequency Domain Spectra | Time Domain Pulse |

The device further included fibre optic coupler, laser controller, depth sensors and two lens/mirrors to focus the beam on the sample. Two distributed feedback (DFB) lasers having centre wavelengths 780 nm were combined with a 50:50 fibre optic coupler. The optical input from the lasers was used to generate carriers in the THz photomixers and utilized as the terahertz emitter and detector. A sine wave generator was designed to provide the bias to the emitter for generating the terahertz radiation. The THz radiation generated by the emitter was guided using the lens and detected by the THz detector. The detected signal from the THz detector was measured using a trans impedance amplifier and then to lock-in amplifier (LIA), a low noise amplifier to amplify the in-phase component of the signal by reducing the noise. LIA was connected to the computer to detect the measured THz signal. Individual optical components of the device were procured and the controllers were used for the operation. All the components were arranged inside the device to guide the THz radiation on the sample. The mirror was placed at the focal length of the lens to get the reference signal. The fabricated apparatus had a signal-to-noise ratio of 50 dB.

TABLE 2
Salient Features of the Fabricated Apparatus

| Sl. No. | System Specifications | Achieved Goal | |
|---|---|---|---|
| 1. | THz system bandwidth | 0.1-0.6 | THz |
| 2. | Spectral Resolution | 0.001 | THz |
| 3. | Spatial Resolution | 10 | μm |
| 4. | Signal-to-Noise Ratio | 50 | dB |

The generated THz radiation from the system is shown in FIG. 5 over a frequency range of 0.1 to 0.6 THz. The THz imaging device was deployed in both transmission mode and reflection mode. The distance between antennas and the lenses was optimized such that the signal was focused properly on the sample. For automatic imaging, a completely automated stepper motor was used to move the sample in the X, Y, Z direction. Per-pixel measurements of the sample were carried out to get the terahertz reflected spectra at each point. The sample was moved with 1 mm spatial resolution to get the entire image. The laser controllers and the lock-in amplifier were fully controlled, and data acquisition speed was enhanced to get a faster image. The terahertz image was obtained by averaging the reflected intensity over a frequency span at each pixel. The current imaging time was 30 minutes to 45 minutes depending on the sample size.

### Example 2: Evaluation of Overlapped Images and Characterization of Cancer Tissue Samples with Fabricated Terahertz Imaging System

To determine the THz reflection differentiation between cancerous and noncancerous tissue, imaging of Formalin Fixed Paraffin Embedded (FFPE) tissue slices was carried out using the fabricated THz device. Ethical clearance was obtained from Rajiv Gandhi Cancer Institute & Research Centre bio-bank to study the FFPE samples. FFPE tissue slices of dimensions ranging from 10 mm to 22 mm (length and/or width) were stained with hematoxylin and eosin (H&E) to produce the pathology image. The H&E slides were marked by an expert pathologist of Apollo hospital, Chennai for confirmation of cancer/noncancerous tissue. The reflection mode setup was particularly utilized for the cancer sample measurement since THz spectra can be reflected from the sample surface irrespective of the sample thickness. Subsequent THz imaging was performed on the FFPE blocks wherein the blocks were positioned directly on the scanning window of the device by mounting them on the motorized platform of the fabricated THz device.

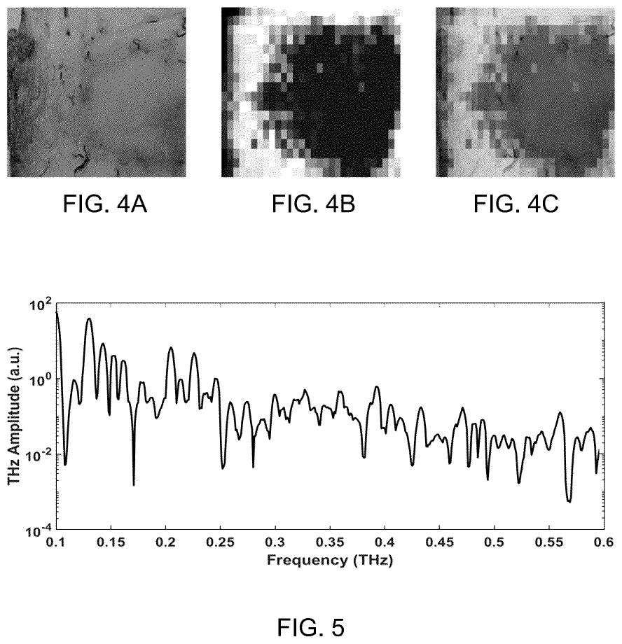

FIG. 4A-4C show overlapping of images obtained, wherein FIG. 4A shows the visible image of one cancer sample captured by RGB camera, FIG. 4B shows the THz image using the fabricated device (using tunable laser) and FIG. 4C shows the overlapping of the visible and THz image. It was observed that the device clearly differentiated between cancerous and noncancerous tissue on the basis of structural differences.

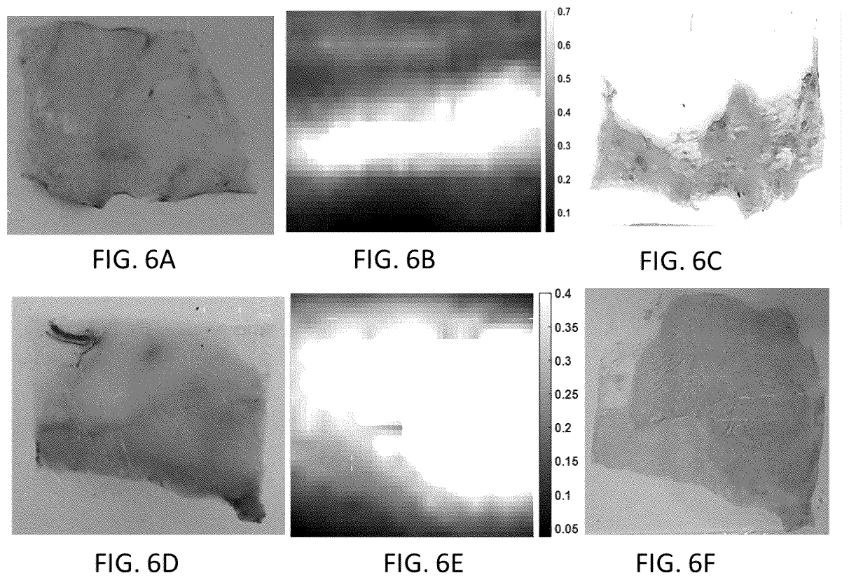

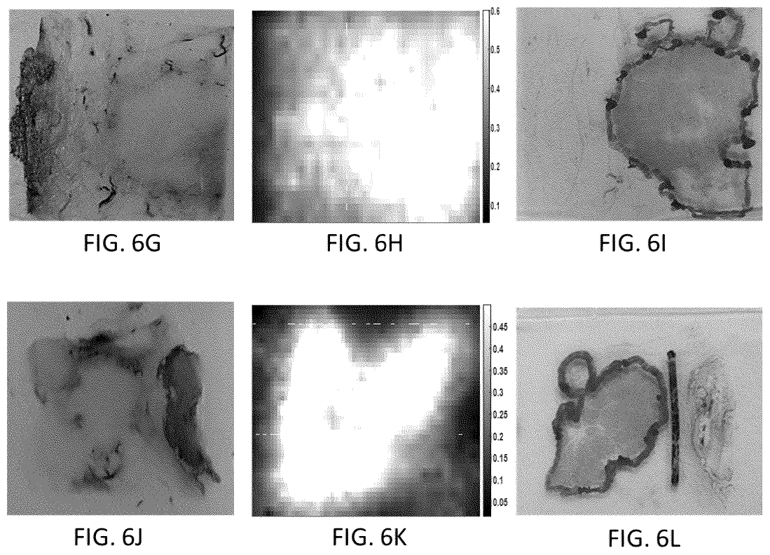

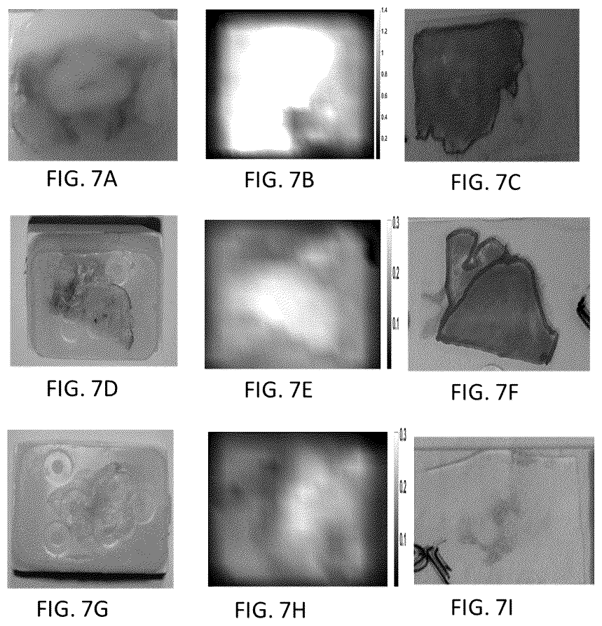

Results of terahertz imaging using tunable laser of four cancer samples and their comparison with histopathology slides is shown in FIG. 6A-6L. The results in FIG. 7A-7I represent THz imaging using femtosecond pulse laser of two completely tumorous tissue samples (FIG. 7A-7C and FIG. 7D-7F) and one partially tumorous tissue sample (FIG. 7G-7I) and their comparison with respective histopathology slides-third image for each sample. The results clearly demonstrated that the magnitude of the reflected THz signal from the cancer region is more than any other region of the tissue. This can be seen in the THz images of FFPE (formalin fixed paraffin embedded) tissue in FIG. 6A-6L, FIG. 7A-7I where the cancer region (represented in white colour in the image bar) dominates the tumour. The THz image of the FFPE tissue was particularly effective in differentiating between the cancer and non-cancerous regions. Hence, the fabricated device was clearly able to differentiate between the cancerous and noncancerous tissues on the basis of structural differences between the samples. Further, it was observed that the fabricated device was able to detect the cancer margin up to mm precision, as desirable in the standardized margin assessment protocol.

### Example 3: Food Quality Monitoring with Fabricated Terahertz Imaging System

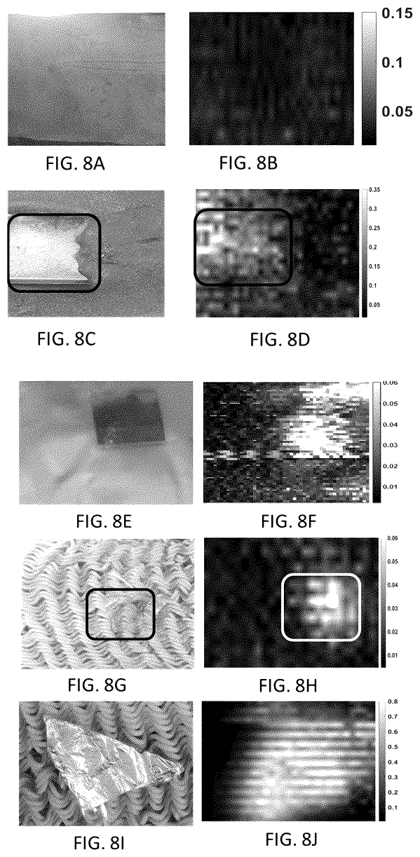

To validate the food quality monitoring capability of the fabricated system, THz imaging of packaged dry food samples with different contaminants such as metal, glass and aluminium foils was carried out. Results of food samples monitoring using terahertz imaging system (with tunable lasers) with their images are shown in FIG. 8A-8J. FIG. 8A and FIG. 8B show the visible image and a THz image of plain chocolate, respectively. FIG. 8C and FIG. 8D show the visible image and a THz image of metal contamination in chocolate, respectively. Further, FIG. 8E and FIG. 8F show the visible image and a THz image of a metal plate inside a baking soda packet, respectively. THz images of glass and aluminium in a noodle packet is shown in FIG. 8H and FIG. 8J, respectively, with their visible light images in FIG. 8G and FIG. 8I, respectively.

In the above shown results of the food samples, a promising intensity variation between the food products and contaminants present inside it was observed. The food products shown a low intensity, represented in grey/black in the image bar whereas the contaminants shown higher intensity, represented in white colour in the image bar, as materials like metal, such as aluminium reflected the THz waves completely. It was observed that the THz system was capable of detecting the foreign bodies inside the food packets based on the variation in reflected THz intensity and was been able to detect the containment objects up to mm precision.

### Example 4: Cryofoam Debonding Measurement with Fabricated Terahertz Imaging System (Non Destructive Testing)

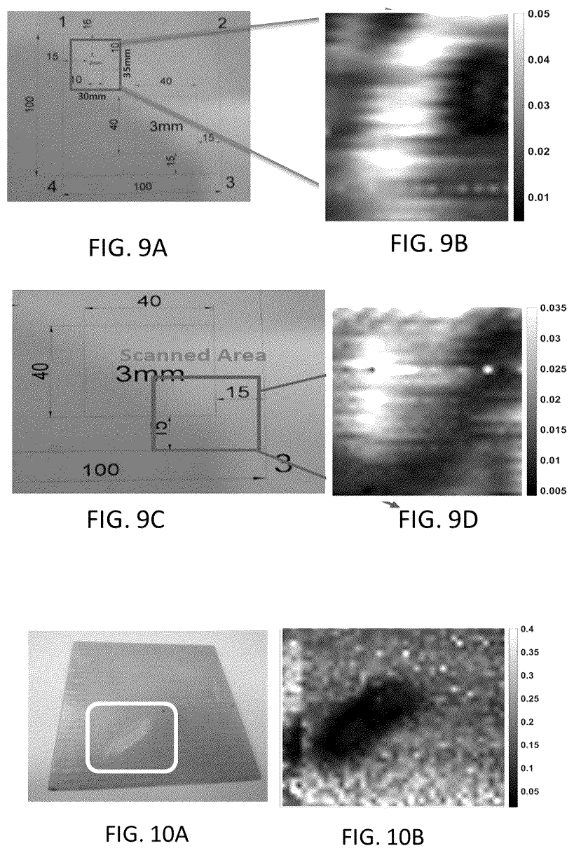

The fabricated THz continuous wave imaging system was tested to validate debonding between substrate-cryofoam or between cryofoam-cryofoam. A cryofoam sample on side 1 with both the unaffected and defective parts (debond) and another cryofoam sample with dimensional region of 35 mm×40 mm on the side 3, were taken for study. The measurements were carried out from 0.32 THz to 0.36 THz with 1 GHz spectral resolution. FIG. 9A-9D shows the images and the THz images of the cryofoam samples with unaffected and defective regions. It was observed that the defective portion of the samples shown higher intensity values in the THz images (FIG. 9B, 9D) (represented in white colour in the image bar) whereas the intensity values of the unaffected region of the cryofoam were comparatively low (represented in grey/black in the image bar).

### Example 5: Measurements of Glass Fiber Reinforced Polymer (GFRP) Samples with Fabricated Terahertz Imaging System (Non Destructive Testing)

The fabricated system with tunable laser was tested to detect impact damages in the Glass Fiber Reinforced Polymer (GFRP). A GFRP sample having dimensions 100×100×1.7 cm, with impact damage was considered for the study. The sample was fixed on a reflective surface (mirror) and mounted on the motorized translational stage, to carry out imaging by raster scanning. FIG. 10A shows the picture of the GFRP sample with impact damage investigated in this study. As evident from the THz image as shown in FIG. 10B, the region with the damage has significantly lower intensity (represented in black colour in the image bar) compared to the neighbouring unaffected regions (represented in grey/white colour in the image bar). It was observed that the scattering of the terahertz radiation in the damaged area was detected by the THz receiver giving a low intensity in that region. Further, as observed in the THz image (FIG. 10B), the system can detect non-uniformity in the sample as well as in the marked area with less intensity.

### Example-5: Thermal Barrier Coating (TBC) Thickness Measurements with Fabricated Terahertz Imaging System (Non Destructive Testing)

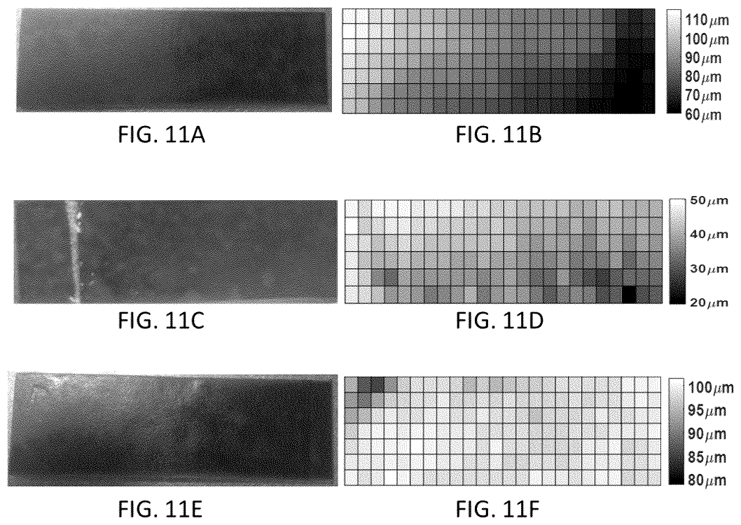

The fabricated system with femtosecond laser was tested to evaluate the degree of degradation of Thermal Barrier Coating (TBC). Top coat thickness of TBC was considered for the study. Assuming the refractive index of the topcoat material, Yttria-Stabilized Zirconia (YSZ) as 4.8, the thickness of the entire specimen was estimated using terahertz-Time Domain Spectroscopy (THz-TDS) reflection mode setup. FIG. 11A and FIG. 11B shows THz-TDS of 1000 hr serviced sample and FIG. 11C shows THz-TDS of 500 hr serviced sample. Results shown that the TBC thickness for 500 hr serviced sample varied between 94 μm—114 μm whereas in case of 1000 hr serviced samples the TBC thickness varied between 32 μm—100 μm, hence, demonstrating loss of TBC with increased service life.

We claim:

1. A terahertz imaging apparatus (100) comprising:
at least one laser source (102), mounted on a laser driver (101), wherein the laser source is configured to generate optical input;
at least one fibre optic coupler (103) configured to split, or combine the signals from the laser source (102);
an emitter (104) comprising a terahertz antenna biased by a signal generator and configured to receive the laser beam from the fibre optic coupler (103) to emit a terahertz radiation;
at least a pair of optical elements (106A, 106B) configured to receive the terahertz radiation from the emitter (104) and guide the terahertz radiation towards a sample (107) positioned at a focal point, wherein the sample is positioned at the focal point using a laser module (111) adapted to visualize the focal point within the visible light spectrum;
a depth sensor (112) positioned adjacent to the terahertz antenna and is configured to obtain the distance of the sample from the emitter (104);
a RGB camera (105) to capture images within the visible spectrum configured to define the scanning area of the sample;
a detector (110) in the terahertz antenna configured to receive the laser beam from the fibre optic coupler and the reflected beam from the sample to form the terahertz image.

2. The apparatus (100) as claimed in claim 1, wherein the laser source (101) comprises a femtosecond pulse laser or a tunable laser.

3. The laser source (101) as claimed in claim 2, wherein the femtosecond pulse laser is included in a terahertz time-domain pulse module comprising an optical delay unit, a prism, at least one mirror, at least one collimator and a photoconductive antenna.

4. The apparatus as claimed in claim 1, comprising a motorized movement mechanism (140) having a platform (124) configured to hold the sample and move the sample in one or more axis.

5. The apparatus as claimed in claim 1, comprising a motorized movement mechanism (140) configured to receive data from the depth sensor (112) and to optimize the position of the sample using a feedback loop.

6. The apparatus as claimed in claim 1, wherein the apparatus (100) is configured to capture raster scan of the sample pixel by pixel based on the position of the platform.

7. The apparatus as claimed in claim 1, wherein the detector (110) is configured to receive reflected radiations from the sample through the optical elements (106A, 106B).

8. The apparatus as claimed in claim 1, comprising a lock-in amplifier (113) and a trans-impedance amplifier (114) to amplify the intensity of the received THz signal.

9. The apparatus as claimed in claim 1, wherein the optical elements (106A, 106B) are mirrors, or lenses selected from silicon lenses or polymethylpentene (TPX) lenses.

10. A terahertz imaging system for optimizing sample position and identifying a region of interest in the sample, the system incorporating the THz imaging device 100 as claimed in claim 1, the system comprising:
a motorized movement mechanism (140) configured to optimize sample position at focal point of terahertz beam, comprising:
a sample holder (124), and stepper motors (128) configured to move the sample in x, y and z directions to enable raster scanning of the sample based on the current position of the motorized platform, and to adjust depth position of the sample based on intensity of the THz radiation measured by the detector (110) and the depth sensor (112);
the visible range camera (105) configured to optically determine scanning area of the sample and to capture real time image of the sample;
a laser unit (150) including the laser source (102) configured to generate a laser beam;
a graphical user interface (GUI) (170) enabling visualization of the measured THz signal over the scanned area along with a visible image thereof;
a controller (160) comprising a computer (162) having at least one processor and memory, communicatively connected to the imaging unit (100), the motorized movement mechanism (140), the laser unit (150) and the display unit (170), comprising:
a terahertz imaging module (210) configured to generate a terahertz image from the raster scan;
a visible image processing module (220) configured to receive real-time image from the RGB camera and to extract visible image data;
a regulator (230) configured to control the function of the one or more laser drivers (101) located within the laser unit (150), the lock-in amplifier (114), and the trans-impedance amplifier (113), and intensity of the laser source (102); and
a function generator (116) configured to provide bias to the emitter (104) and reference signal to the lock-in amplifier (114).

11. The system as claimed in claim 10, wherein the laser source (102) is a femtosecond pulsed laser or a continuous wave tunable laser.

12. The system as claimed in claim 10, wherein the GUI (170) is configured to display real-time images of the sample.

13. The system as claimed in claim 12, wherein one or more parameters of the controller are configurable by the user through the GUI.

14. The system as claimed in claim 10, wherein the computer (162) comprises a communication interface for wired or wireless communication, configured to communicate in real-time with a remote host.

15. The system as claimed in claim 14, wherein the wireless communication is via a protocol selected from Bluetooth, WiFi and Zigbee.

16. A method (300) of optimizing a position of a sample in a terahertz imaging system and identifying a region of interest in the sample, the method comprising:
capturing (401) a terahertz image of the sample placed in a motorized platform using a terahertz imaging apparatus, comprising the steps of:
generating (301) optical input by at least one laser source;
splitting or combining (303) the signals from the laser source in a fibre optic coupler;
receiving (305) the beam from the fibre optic coupler in a THz emitter biased by a signal generator and emitting terahertz radiation;
guiding (307) the terahertz radiation from the emitter towards a sample positioned at a focal point through optical elements;
obtaining the distance of the sample from the emitter (309) by a depth sensor;
defining the scanning area of the sample (311) by a RGB camera within the visible spectrum;
receiving the reflected beam from the sample (313) in a detector in the terahertz antenna; and
measuring the intensity of the reflected beam after amplification;
optimizing (403) the sample position at the focal point in a position optimizing unit comprising:
receiving (315) data from the depth sensor and measured intensity of the reflected beam in a feedback loop, and optimising the distance between the sample and the device to position the sample at the optimal position to maximise the measured intensity;
generating (405) a terahertz image from the raster scan in a terahertz imaging module in the controller;
receiving (407) real-time images from a RGB camera and extracting visible image data; and
overlaying (409) the terahertz image with the visible image to specify the scan region and detecting the region of interest based on the terahertz image.

17. The method as claimed in claim 16, wherein step 403 comprises guiding the motorized movement mechanism 140 to optimize the position of the sample at the focal point.

18. The method as claimed in claim 16, comprising displaying the real-time scanned images of the sample in a graphical user interface (GUI).

19. The method as claimed in claim 18, comprising setting one or more parameters of the controller through the GUI.

20. The method as claimed in claim 16, wherein the detecting the region of interest comprises using an image processing algorithm to process the THz image.

21. The method as claimed in claim 16, comprising communicating wirelessly in real-time through a communication interface provided with a user authorization module.

22. The method as claimed in claim 16, comprising setting one or more parameters of the controller via a software application installed in a mobile device.

23. The method as claimed in claim 16, comprising storing data in cloud storage or a local database.

24. The method as claimed in claim 16, comprising enhancing contrast of the THz image by an edge detection algorithm or a point spread function deconvolution or a histogram equalization algorithm or a machine learning algorithm or a deep learning algorithm.
